(19) United States
(12) Patent Application Publication
(10) Pub. No.: US 2008/0178476 A1
(43) Pub. Date: Jul. 31, 2008

(54) Sharpener Blade

(75) Inventor: Fritz Luttgens, Erlangen (DE)

Correspondence Address: LERNER GREENBERG STEMER LLP, P O BOX 2480, HOLLYWOOD, FL, 33022-2480, US

(73) Assignee: KUM LIMITED, Trim (IE)

(21) Appl. No.: 12/019,334

(22) Filed: Jan. 24, 2008

(30) Foreign Application Priority Data
Jan. 24, 2007 (EP) 07 001 463.4

(51) Int. Cl. B26B 21/58

(52) U.S. Cl. 30/346.54

(57) ABSTRACT

A sharpener blade is made of a steel body for sharpening a colored, graphite or cosmetic pencil. On the steel body is a chemically bonded, inorganic protective coating that contains at least one element selected from the group containing the metals of the main groups III and IV and the B-groups of the periodic system of elements, and oxides, ceramics, nitrides, carbides, silicides and borides of these. A sharpener blade of this type has permanent protection against corrosion, along with high sharpness and hardness levels. At the same time, it can be colored.

### CROSS-REFERENCE TO RELATED APPLICATION

This application claims the priority, under 35 U.S.C. § 119, of European application EP 07 001 463.4, filed Jan. 24, 2007; the prior application is herewith incorporated by reference in its entirety.

### BACKGROUND OF THE INVENTION

### Field of the Invention

The invention relates to a sharpener blade made of steel. Specifically, the invention relates to a blade for sharpening a colored, graphite or cosmetic pencil.

In order to achieve the most durable, high functional quality in a sharpening tool for sharpening pencils, such as graphite, colored or cosmetic pencils, a sharpener blade installed in the body of a sharpener must be capable of withstanding high mechanical stresses. To maintain the most consistent level of sharpness and attachment stability possible for the installed sharpener blade over the lifespan of the sharpener, the sharpener blade is customarily made of hard, special steel having a high carbon content. The sharpener blade must be capable, for example, of shaving off the hard graphite of pencil lead, without significant loss of sharpness. The sharpener blade must also retain the desired cutting line over its entire lifespan, especially in the case of cosmetic pencils.

Disadvantageously, hard special steel having a high carbon content, which fulfills the requirements placed on a sharpener blade, exhibits a relatively high susceptibility to corrosion. Corrosion of a sharpener blade made of steel is further accelerated when the sharpener blade, as is customary, is placed in direct contact with the body of the sharpener and the screws or rivets that are used to attach it to the body of the sharpener. For example, if the sharpener body or the fastening element is made of a nobler metal than iron or of a nobler metal alloy, corrosion of the sharpener blade is accelerated by local element interaction. On the other hand, corrosion is also promoted if the sharpener body is made of non-metallic materials, such as plastic or wood, because these materials, or some of their components, can also have a corrosive effect.

Attempts to protect the surface of a sharpener blade made of steel from corrosion by coating it with a lacquer have produced no feasible solution. The frequent use of a sharpener blade, in which material is worn off, rapidly removes such a lacquer made of organic substances. A passivation of the steel, for example by alloying it with chromium, is not possible, however, since the steel then loses the hardness that is required for a sharpener blade.

### SUMMARY OF THE INVENTION

It is accordingly an object of the invention to provide a sharpener blade that overcomes the above-mentioned disadvantages of the prior art devices of this general type, and which is formulated for a colored, graphite or cosmetic pencil, and has the longest possible lifespan.

With the foregoing and other objects in view there is provided, in accordance with the invention, a sharpener blade for one of a colored pencil, a graphite pencil and a cosmetic pencil. The sharpener blade contains a steel body, and an inorganic protective coating chemically bonded to the steel body and containing at least one element selected from the group consisting of metals of main groups III and IV of the periodic system of elements, metals of the B-groups of the periodic system of elements, and oxides, ceramics, nitrides, carbides, silicides and borides of these.

The object is attained according to the invention with a sharpener blade made of steel, having a chemically bonded inorganic protective layer, containing at least one element selected from the group containing the metals of the main groups III and IV and the B-groups of the Periodic System of Elements, and oxides, ceramics, nitrides, carbides, silicides and borides of these.

The invention is based upon the idea that a lacquer intended to protect the sharpener blade made of steel from corrosion will not bond adequately to steel. With a sharpener that is in regular use, this results in a rapid abrasion or cracking of the layer of lacquer, especially on the sharpener blade, so that the sharpener blade overall becomes unsightly, and the steel that is then exposed again becomes susceptible to corrosion.

In a further step, the invention is based upon the knowledge that chemical bonding is associated with stronger bonding forces than physical bonding. But a lacquer layer is bonded to a structure especially via adhesion and/or via a microscopic positive connection. The disadvantages known to be associated with such a physical bond are overcome by equipping the sharpener blade made of steel with a protective coating having an inorganic composition, which is capable of bonding chemically with the steel. The metals of the main groups III and IV and the B-groups of the Periodic System of Elements, along with oxides, ceramics, nitrides, silicides and borides of these, are suitable for a protective coating of this type.

The invention has the further advantage that the chemically bonded protective coating is substantially thinner than a known lacquer, with the same corrosion-inhibiting effect. In addition, as a result of the strong bonding forces of a chemically bonded protective layer, a coating is achieved that is able to withstand the heavy mechanical stresses on the sharpener blade over its lifespan. Overall, for example, less material is used than with a lacquer layer, which is associated with a cost advantage. Furthermore, the materials that are used can be easily subjected to a recycling process.

In the case of a metal, the protective coating is attached to the sharpener blade via a metallic bond. In this a mixed phase can occur, especially between the steel and the metal that is applied as a protective coating. Suitable metal coatings can be produced, for example, via reductive/galvanic depositions of metal cations, metallates and/or metal complexes on the surface of the sharpener blade. By selecting suitable reaction media, such as complexing agents or solvents, metal coatings of this type can be deposited by varying the electrochemical series. Application can especially be achieved via a simple dipping process.

A metal oxide or a mixed metal oxide of the aforementioned metals can be generated on the surface of the sharpener blade via the simultaneous addition of a suitable oxidation agent or by selecting suitable counter anions. A metal oxide or a mixed metal oxide can also be produced by vapor deposition or by vapor-phase deposition of a volatile, oxygen-containing compound of the respective metal, or by deposition from a solution containing a metal salt and an oxidation agent. For the protective coating, a metal layer can also be chemically bonded to the sharpener blade especially over a transition layer, such as a metal oxide or a mixed metal oxide.

The term “oxides” refers to both oxides of the aforementioned metals of alternating and combined oxidation stages, and those mixed oxides that contain a plurality of these metals. Ceramics are those materials that contain the aforementioned metal oxides that have at least 30 vol.-% crystalline structure. For example, an Al₂O₃ layer applied to the sharpener blade can also be characterized as a ceramic.

The terms nitrides, carbides, silicides and borides include those chemical compositions or compounds of the aforementioned metals that contain nitrogen, carbon, silicon and/or boron. These need not have a stoichiometric composition. A chemical bonding to steel is possible directly or via transition phases. Compounds of this type are especially advantageous, as they ordinarily have a high hardness level.

Both the protective layer as such and a transition phase or transition layer that may optionally be present between the protective coating and the steel can have a stoichiometric or non-stoichiometric composition. In this manner, chemical bonding can occur by filling the lattice positions with foreign atoms or by inserting the same into the volume of lattice structures that are present.

With the chemical bonding of the inorganic protective coating to the steel of the sharpener blade, a permanent and wear-resistant protection against corrosion is achieved. The stability, cutting strength and wear resistance of a sharpener blade that is coated in this manner is substantially increased. The contact interaction between the steel of the sharpener blade and the related substrate materials, e.g. the sharpener body or the mounting elements, is minimized.

In one advantageous embodiment of the invention, the steel is a carbon-free steel having a Rockwell hardness of greater than 61. The Rockwell hardness is an internationally recognized unit of measurement of the hardness of technical surfaces. The customary abbreviation for this is HRC, wherein HR stands for Hardness Rockwell, and C stands for Cone. The Rockwell hardness indicates the penetration depth of a diamond cone into the measured surface. Especially, a steel having a Rockwell hardness of greater than 65 is used. A special steel of this type has a high concentration of carbon, between 0.98 and 1.05 wt.-%, a concentration of silicon of between 0.3 and 0.5 wt.-%, a concentration of manganese of between 0.4 and 0.6 wt.-% and other low alloyed components, such as aluminum, copper, chromium, nickel and molybdenum. A steel of this type is capable of withstanding the high mechanical stresses placed upon a sharpener blade, but alone exhibits a high susceptibility to corrosion.

Preferably, the protective coating contains at least one element, which is selected from the group containing the metals of the main groups III and IV, with the exception of In, TI, Sn and Pb, and the B-groups Ib, IVb, Vb, VIb, VIIb and VIIIb, with the exception of Tc, Fe and Os, of the Periodic System of Elements, and oxides, ceramics, nitrides, carbides, silicides and borides of these.

In a further preferred embodiment, the protective coating contains at least one element that is selected from the group containing Cu, Ag, Au, Ti, Zr, V, Nb, Ta, Cr, Mo, W, Pd and Pt, and oxides, ceramics, nitrides, carbides, silicides and borides of these.

Cu, Ag, Au, Pd and Pt, as noble metals, are suitable for protecting the steel against corrosion. If the body of the sharpener is made of a nobler metal than copper, a coating with Ag, Au, Pd or Pt should be selected. Copper can especially also be bonded to the sharpener blade via a transition phase of a copper oxide. The nobler metal Ag, Au, Pd and Pt can also be bonded to the copper, and especially to the copper oxide. In this manner, local element interaction that will accelerate corrosion is prevented. Titanium and chromium are suitable due to their ability to form stable oxidation layers, and as a protective coating against corrosion. In addition to their metallic coloration, vanadium and chromium possess high mechanical stability. Titanium, chromium, molybdenum and wolfram are especially well suited as a protective coating in their form as metal nitrides, since metal nitrides of this type have a high hardness level and stability. Also due to its property of forming a passivation layer, niobium is suitable for use as a protective coating. Furthermore, niobium is known to be a strong carbide former. Especially in the case of oxides, ceramics, nitrides, carbides, silicides and borides, a protective coating of high mechanical stability and hardness can be achieved, wherein additionally a strong passivation of the steel against corrosion is achieved via a transition phase into the metallic phase. Wolfram can also be applied to the sharpener blade as an alloy component, especially in the form of a wolfram carbide. This makes the sharpener blade especially resistant and hard.

The invention is not limited to the formation of a single layer. Rather, the protective coating can also contain a combination of various layers. For example, a mixed oxide layer can be combined with a nitride or boride layer to create a hardening.

Advantageously, the protective coating contains at least one layer of a metal and/or a metal oxide. Especially, the metal oxide, as a transition phase with decreasing metal content, can facilitate the bonding of the metal to the steel of the sharpener blade. It is further advantageous for the protective coating to contain at least one layer of a metal nitride, metal carbide, a metal silicide, a metal oxide or a metal boride. Each of the proposed layers can be bonded to the sharpener blade separately or in combination. Especially if the metal does not form an alloy with iron, the metal is preferably bonded to the sharpener blade via a metal nitride, a metal carbide, a metal silicide, a metal oxide or a metal boride. Coatings of this type exhibit a high hardness level, so that the sharpener blade is also protected against mechanical wear and tear. With a protective coating of this type, the sharpener blade is also hardened.

With respect to the aforementioned coatings, it is beneficial in terms of the corrosion resistance of the steel to form the coating from a metal, a metal nitride, a metal carbide, a metal silicide, a metal oxide or a metal boride, in such a way that it transitions continuously in a transition phase to the metallic phase of the steel. In this manner, an especially effective bonding of the protective coating and an effective protection against corrosion are achieved.

A metal transition layer can be created, for example, via a targeted metal diffusion into the interior of the sharpener blade via a thermal treatment, via a vapor-phase deposition with metals, metal salts or organometallic compounds, especially with metal carbonyls.

A metal oxide, metal boride, metal nitride, metal carbide or metal silicide transition layer can be generated via a targeted metal diffusion into the interior of the sharpener blade via a thermal treatment, via vapor-phase deposition with metals, metal salts or organometallic compounds, especially with metal carbonyls, with simultaneous oxidation, or via treatment of the sharpener blade in a nitrogen plasma and/or a simultaneous, pre- and/or post-thermal treatment, and/or vapor-phase deposition and/or from a solution with borides, borates, silicides, silicates and/or covalent boron and/or silicon compounds.

A metal coating with an insulating intermediate layer of a metal oxide can, in turn, be generated on the surface of the sharpener blade via a reductive/galvanic deposition of metal cations, metallates and/or metal complexes from a solution, while controlling the pH level and simultaneously adding an oxidation agent.

In one preferred embodiment of the sharpener blade, the blade has a protective coating, wherein a layer of Cu, Ag, Au, Pt or Pd transitions to the metallic phase of the steel via a mixed oxide phase containing iron. In this, the metal layer is preferably produced in a single processing step through reductive direct deposition by dipping the sharpener blade in a solution of salts of the aforementioned metals, in the simultaneous presence of a sufficiently weak oxidation agent, while controlling the pH level, with the simultaneous formation of an oxide intermediate layer.

With this procedure, first an iron oxide layer forms on the dipped sharpener blade, on which the metal is then chemically deposited. In this, copper can also be present as copper oxide. Silver, gold, palladium and platinum are present in metallic form. The latter can be applied to the copper layer, and especially a copper oxide layer, of the body of the sharpener especially for optical reasons or as protection against corrosion, in relation to a sharpener body made of a nobler metal than copper. Water or alcohols, especially ethanol, methanol or isopropanol, can be used as the solvent for the metal salts. Nitrates, sulfates, acetates, propionates, citrates and acetonitrile complexes have successfully been used as salts.

In a single processing step, namely dipping the sharpener blade into the described solution, it is therefore possible to coat the sharpener blade with a corrosion-inhibiting protective layer of a metal, which is bonded to the steel via a metal oxide layer. With this, the pre-coatings of steel with tin, lead or zinc, which up to now have been unavoidable, are no longer necessary to apply a corrosion-inhibiting metal coating.

The metal coating can be applied over the entire surface or only a portion of the surface of the sharpener blade. Because the sharpener blade, especially at its cutting edge, is positioned removed somewhat from the body of the sharpener, to prevent local element formation it is sufficient to coat the sharpener blade in the area of the points at which it is attached to the sharpener body. Especially, the cutting edge of the sharpener blade can be sharpened again following the dipping process, without causing the protective coating to break away. In this manner, the sharpener blade is sufficiently sharp, but is also reliably protected against local element interaction.

The protective coating can especially contain a metal nitride or metal carbide, especially of the metals Ti, Zr, Hf, V, Nb, Ta, Cr, Mo and/or W. For example, first a metal layer is applied to the sharpener blade, especially via a galvanic dipping process. In this, the galvanically applied metal is chemically bonded to the steel. The metal nitride or the metal carbide is then obtained through the targeted introduction of nitrogen or carbon. This can be achieved, for example, by treating the coated sharpener blade using plasma. The plasma can be generated by an electrical discharge, for example via an electric arc.

Advantageously, the metal nitride or the metal carbide is produced via plasma deposition. In this, the sharpener blade is used as a cathode, wherein the metal to be applied is used as an anode or is added to the vapor chamber as a volatile compound. By igniting a nitrogen plasma, for example, the metal of the anode or from the volatile compound precipitates with intercalary nitrogen atoms onto the surface of the sharpener blade. With this, a transition phase forms between the steel and the metal nitride, in which nitrogen atoms occupy lattice positions in the metal. A metal carbide can also be produced via plasma deposition, wherein, for example, a methane atmosphere is created.

Preferably, the metal nitride or the metal carbide is generated in such a way that the composition of the protective coating has a decreasing concentration of the metal as it approaches the metal phase of the steel. To accomplish this, in a first phase a nitride or carbide layer is especially applied to the sharpener blade in an atmosphere containing nitrogen or carbon. The metal or a plurality of metals is then added to the vapor atmosphere, each as a volatile compound, so that the metal, the metals or the metal compounds, together with nitrogen or carbon atoms, are deposited onto the sharpener blade. In a final phase, the nitrogen or carbon portion of the vapor atmosphere can then be reduced or completely removed. In this process, the concentration gradient of the metal in the protective coating can be adjusted continuously or in stages.

With the plasma deposition process, the layer thickness can further be specifically adjusted, so that with a desired corrosion protection, the sharpener blade is hardened, wherein at the same time the necessary sharpness is maintained.

The following compounds are particularly well suited for the plasma deposition process: Boric acid esters, boranes, alkyl and/or aryl boranes, silicon tetrachloride, 1-4 substituted alkyl and/or aryl derivatives of these, e.g. trimethylsilyl chloride, titanium alcoholates, titanium tetrachloride and 1-4 substituted alkyl, alkyloxy, aryl and/or aryloxy derivatives of these, biscyclopentadienyl titanium dichloride, vanadyl acetylacetonate, vanadium oxychloride, vanadium(III)chloride-tetrahydrofurane, vanadyl naphthenate, cyclopentadienyl niobium(V)tetrachloride, niobium(V)bromide, niobium(V)ethoxide, niobium(IV)-2-ethylhexanoate, niobium(V)fluoride, pentakis(dimethylamino)tantalum(V), cyclopentadienyl tantalum tetrachloride, tantalum(V)bromide, tantalum(V)chloride, tantalum(V)ethoxide, tantalum(V)tetraethoxy acetylacetonate, chromium carbonyl, chromium(III)-2-ethylhexanoate, chromium(III)acetylacetonate, chromium(III)naphthenate, chromyl chloride, molybdenum and wolfram compounds that correspond to the proposed chromium compounds up to chromyl chloride, and zirconium and hafnium compounds that correspond to the proposed titanium compounds.

Surprisingly, it has been found that when plasma deposition is used, favorable steel of lower hardness levels, especially a favorable noble steel, can be used. In this case, the hardness and the corrosion protection of the sharpener blade are realized by the applied protective coating. When hard steel is used, the plasma deposition process can be performed at temperatures below 800° C., especially at temperatures below 300° C. The hardness of the carbon-rich, low-alloyed steel is worsened substantially at temperatures above 800° C., as at these temperatures phase changes occur.

In one particularly advantageous embodiment, the protective coating is used to color the sharpener blade. For example, with titanium nitride a golden coloration of the sharpener blade can be achieved. With corresponding mixtures of transition metals, intensive color tones of the widest shades can be established. Suitable volatile compounds can also be deposited from a nitrogen-free vapor phase onto the steel surface as mixed oxides, by decomposing the starting compounds. When mixed oxides are used, the colors can be derived from the oxidation stages of the metals that are used. Especially, the widest range of oxidation stages of niobium, tantalum or vanadium can be used for this. A colored inorganic protective coating of this type, which is chemically bonded to the steel of the sharpener blade, is permanent, is not susceptible to mechanical stresses, and especially does not affect the sharpness of the blade. In this manner, colored sharpener blades can be created, the properties of which, as compared with an applied lacquer, are not worsened, but are instead improved. In this manner, sharpeners can be provided with colored sharpener blades, creating aesthetically desirable office supplies with high functional value.

Other features which are considered as characteristic for the invention are set forth in the appended claims.

Although the invention is illustrated and described herein as embodied in a sharpener blade, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1A is a diagrammatic, plan view of a first embodiment of the sharpener blade made of steel according to the invention;

FIG. 1B is a diagrammatic, sectional view of the sharpener blade made of steel according to FIG. 1A, with a protective coating formed of a chromium nitride layer and a niobium oxide layer;

FIG. 2A is a diagrammatic, plan view of a second embodiment of the sharpener blade with a protective coating formed of a copper layer and a mixed oxide transition phase; and

FIG. 2B is a diagrammatic, sectional view of the sharpener blade according to FIG. 2A with the protective coating formed of the copper layer and the mixed oxide transition phase.

### DETAILED DESCRIPTION OF THE INVENTION

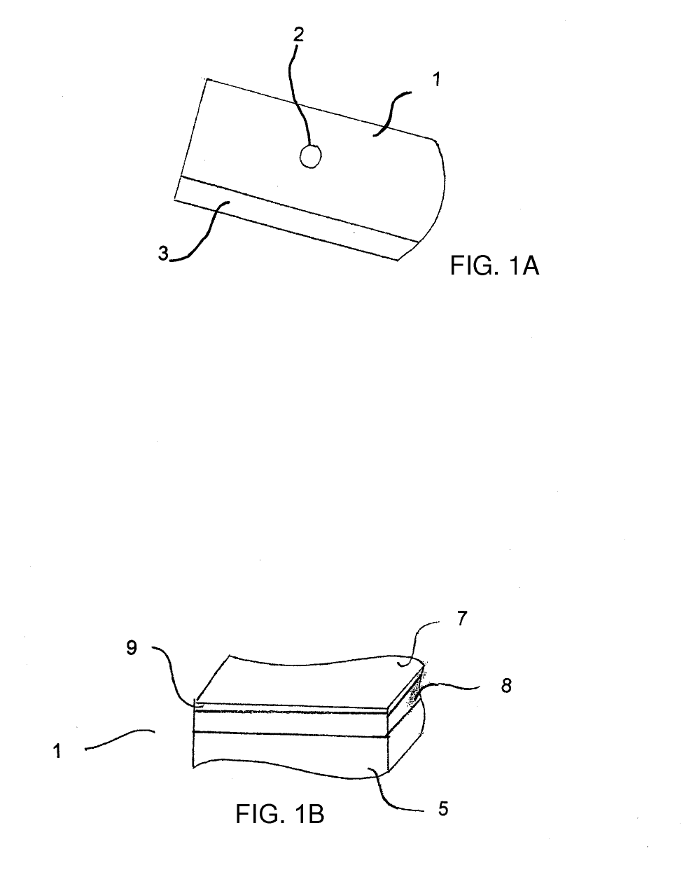

Referring now to the figures of the drawing in detail and first, particularly, to FIG. 1A thereof, there is shown a sharpener blade 1 made of an alloyed noble steel. The sharpener blade 1 is intended for use in a sharpener body, and therefore is equipped with a bore hole 2, via which it can be fastened to the body of a sharpener, for example by a screw or a rivet. The sharpener blade 1 has a cutting edge 3 for sharpening the tip of a colored or graphite pencil, or even a cosmetic pencil, in which the material of the sharpener blade 1 tapers to form a tip.

To apply a protective coating, the sharpener blade 1, as a cathode, was first coated with a chromium nitride via plasma deposition in a nitrogen atmosphere, with the addition of a chromium carbonyl. The plasma was generated at a voltage of approximately 1,000 V and a temperature of between 200 and 250° C. To control the morphology and coloration, a titanium alcoholate was then added to the vapor chamber. Finally, a niobium(IV)-2-ethylhexanoate was added, with a reduction of the nitrogen concentration, which decomposes and precipitates onto the surface, forming niobium oxide and/or niobium nitride. By controlling the nitrogen component, the share of niobium oxide in the protective coating that is created can be adjusted. The coloration of the protective coating can be varied over the resulting oxidation stages.

The surface of the sharpener blade 1 that was treated in this manner is schematically illustrated in an enlarged section in FIG. 1B. A surface of a steel body 5 and the resulting protective coating 7 that is applied to it, which is chemically bonded to the metallic phase of the steel body 5, are apparent. As is shown here, the protective coating 7 has a layer 8 of a chromium and titanium nitride, which rests on the steel body 5. In this, the nitrogen atoms of the metal nitride occupy lattice positions in the metallic steel compound, with alternating valences. It is further shown that an additional layer 9 containing niobium oxide and niobium nitride is bonded to the layer of chromium and titanium nitride 8. From the last layer 9, a coloration of the treated sharpener blade 1 results, which can be adjusted almost infinitely via the selection of suitable processing parameters. Additionally or separately, the already mentioned tantalum or vanadium compounds can also be used to produce the layer 9.

With the chromium/titanium nitride coating, which is chemically bonded to the steel of the sharpener blade 1, hardening is achieved in addition to the coloration. In this manner, the steel body 5 is reliably protected against abrasion or wear and tear. In general, by using favorable noble steel, a sharpener blade can be created, which is capable of withstanding the conditions in terms of hardness, wear and tear, and corrosion that occur during sharpening. In addition, the sharpener blade 1 can be provided with coloration through the coating.

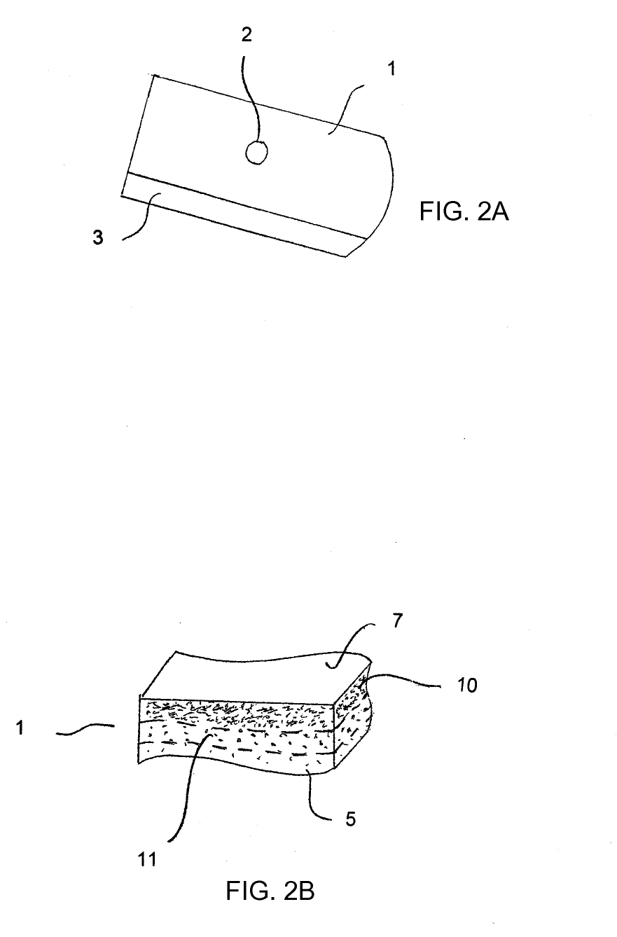

In FIGS. 2A and 2B, the sharpener blade 1 is again shown, with the bore hole 2 and the cutting edge 3. In this case, the sharpener blade 1 is made of a carbon-rich steel forming the steel body 5. The steel has a Rockwell hardness of 65.

For the coating process, the sharpener blade 1 is dipped into an aqueous solution of copper nitrate and nitric acid. The pH level is adjusted to between 1 and 4. With the simultaneous oxidation of the iron to an iron oxide, it is possible to deposit copper onto the steel of the sharpener blade. The copper is chemically bonded to the steel of the sharpener blade 1 with the formation of a mixed oxide transition phase, especially of iron oxide.

From the detailed view, the structure of the resulting protective coating 7 can be seen. The protective coating 7 has a surface layer 10 of copper, wherein a transition phase 11 formed of a mixed oxide is formed between the copper of the layer 10 and the steel body 5. Along this transition phase 11, the layer 10 of copper transitions to the metallic phase of the steel body 5, with a continuously decreasing ratio of copper. Although copper and iron do not form an alloy, with the proposed, surprisingly simple process a copper layer 10 can be chemically bonded to the steel body layer 5.

With the copper layer 10 that is chemically bonded to the steel, the sharpener blade 1 is permanently protected against corrosion. In addition, the copper layer 10 has a visually appealing coloration. Furthermore, a layer of silver, gold, palladium or platinum can be applied as an additional layer to the copper layer 10 or a copper oxide layer in a dipping process.

1. A sharpener blade for one of a colored pencil, a graphite pencil and a cosmetic pencil, the sharpener blade comprising:
a steel body; and
an inorganic protective coating chemically bonded to said steel body and containing at least one element selected from the group consisting of metals of main groups III and IV of the periodic system of elements, metals of B-groups of the periodic system of elements, and oxides, ceramics, nitrides, carbides, silicides and borides of these.

2. The sharpener blade according to claim 1, wherein said steel body is formed of a carbon-rich steel having a Rockwell hardness of greater than 61.

3. The sharpener blade according to claim 1, wherein said inorganic protective coating contains at least one element selected from the group consisting of the metals from the main groups III and IV, with the exception of In, TI, Sn and Pb, and the B-groups Ib, IVb, Vb, VIb, VIIb and VIIIb, with the exception of Tc, Fe and Os, of the Periodic System of Elements, and oxides, ceramics, nitrides, carbides, silicides and borides of these.

4. The sharpener blade according to claim 1, wherein said inorganic protective coating contains at least one element selected from the group consisting of Cu, Ag, Au, Ti, Zr, Hf, V, Nb, Ta, Cr, Mo, W, Pd and Pt, and oxides, ceramics, nitrides, carbides, silicides and borides of these.

5. The sharpener blade according to claim 1, wherein said inorganic protective coating contains at least one layer of a metal.

6. The sharpener blade according to claim 1, wherein said inorganic protective coating contains at least one metal oxide layer.

7. The sharpener blade according to claim 1, wherein said inorganic protective coating contains at least one layer of a material selected from the group consisting of a metal nitride, a metal carbide, a metal silicide, a metal oxide and a metal boride.

8. The sharpener blade according to claim 5, wherein said inorganic protective coating transitions continuously through a transition phase from one of a metal, a metal nitride, a metal carbide, a metal silicide, a metal oxide and a metal boride to a metallic phase of said steel body.

9. The sharpener blade according to claim 8, wherein said inorganic protective coating has a coating of one of Cu, Ag, Au, Pt and Pd which transitions to said metallic phase of said steel body through a mixed oxide phase that contains iron.

10. The sharpener blade according to claim 7, wherein said inorganic protective coating contains one of a metal nitride and a metal carbide produced via plasma deposition.

11. The sharpener blade according to claim 10, wherein said inorganic protective coating of one of said metal nitride and said metal carbide has a composition that contains a decreasing concentration of metal as it approaches a metallic phase of said steel body.

12. The sharpener blade according to claim 10, wherein said inorganic protective coating contains a metal nitride of at least one of metals Ti, Zr, Hf, V, Nb, Ta, Cr, Mo and W, produced via plasma nitration.

13. The sharpener blade according to claim 12, wherein nitrides are generated via deposition from a nitrogen plasma using one of an anode and volatile compounds of a selected metal or selected metals.

14. The sharpener blade according to claim 6, wherein said metal oxide layer of said inorganic protective coating is produced via vapor deposition and decomposition of a volatile, oxygen-containing compounds of said metal.

15. The sharpener blade according to claim 1, wherein said inorganic protective coating is colored.

16. The sharpener blade according to claim 10, wherein said inorganic protective coating contains at least one of Ti, Zr, Hf, V, Nb, Ta, Cr, Mo and W, produced via plasma deposition.

17. The sharpener blade according to claim 6, wherein said metal oxide layer of said inorganic protective coating is produced via vapor deposition from a solution containing a metal salt and an oxidation agent.
